(19) United States
(12) Patent Application Publication
(10) Pub. No.: US 2011/0125320 A1
(43) Pub. Date: May 26, 2011

(54) Method And Apparatus For Planning And/Or Control Of A Robot Application

(75) Inventors: Thomas Bongardt, Augsburg (DE); Dirk Jacob, Marktoberdorf (DE); Thomas Kohler, Gersthofen (DE); Klaus Schlickenrieder, Horgau (DE); Martin Weiss, Margertshausen (DE)

(73) Assignee: KUKA ROBOTER GMBH, Augsburg (DE)

(21) Appl. No.: 12/948,967

(22) Filed: Nov. 18, 2010

(30) Foreign Application Priority Data
Nov. 20, 2009 (DE) 10 2009 054 112.8

(51) Int. Cl. B25J 9/00

(52) U.S. Cl. 700/245; 901/50

(57) ABSTRACT

A method according to the invention for planning and/or controlling a robot application (1) on the basis of system and/or process parameters (M1, . . . M7, G1, . . . G7, B1, K1, S1, H1, W1, F1, U1, R1), includes these steps:
storing parameter values, and
planning and/or controlling the application on the basis of stored parameter values,
wherein parameters are managed with the aid of a graph structure (FIG. 2).

The present invention relates to a method and a device for planning and/or controlling a robot application on the basis of system and/or process parameters.

Work processes of one or more robots are sometimes planned offline today on the basis of process and robot models, and are controlled in operation on the basis of system parameters such as automatic controller coefficients and calibrated model parameters. Up to now, such system and process parameters have been managed separately, some of them for example in a path planning system, some in a total system controller, and some in the individual robot controllers. This makes it difficult to plan and control the robot application, in particular its optimization and the exchange and removal of existing or the addition of new application components, such as other robot tools, additional robots, etc.

WO 00/25185 A1 proposes a hierarchical knowledge base for linking tool and process stereotypes, so-called templates. DE 102 06 903 A1 teaches a tree-structured manufacturing execution system (MES), in which sensor, actuator and SPS objects are linked to each other. The use of a graph structure for managing system and process parameters of a robot application is not derived from these object-oriented solutions.

The object of the present invention is to improve the planning and/or control of a robot application on the basis of system and/or process parameters.

This object is satisfied by a method having the features of claim 1. Claim 8 protects a device, claims 9 and 10 a computer program or computer program product, in particular a data medium or storage medium, for carrying out a method according to claim 1. The subordinate claims relate to advantageous refinements.

A method and or device according to the invention is used for planning and/or controlling a robot application on the basis of system and/or process parameters.

A robot application as specified in the present invention includes in this case in particular the construction and working process of one or more robots, preferably industrial robots. Accordingly, the planning for a robot application may include in particular the selection, dimensioning, configuration and/or parameterization of at least one robot, robot-guided tool and/or robot controller on the one hand, and on the other hand the process planning, in particular the path planning and preferably the optimization thereof. Correspondingly, the controlling of a robot application may include in particular the controlling of work sequences, in particular motion sequences of one or more robots and of other application components, such as tools (preferably robot-guided), transport equipment and the like. At the same time, for a more compact representation, controlling in the meaning of the present invention also refers to closed-loop control, i.e., outputting settings to actuators while sensor values are returned as feedback.

The application is planned or controlled on the basis of stored system and/or process parameters. Such parameters may include in particular model parameters of a kinematic or dynamic model of an application component, in particular of a robot or of a robot component, such as mass(es), center of gravity position(s), moment(s) of inertia, stiffness(es), damping(s), friction coefficient(s), geometric value(s) such as axis position(s) and axis distance(s), transmission ratio(s), control parameters such as regulator coefficients, and/or environmental and process parameters such as workpiece parameters, contact rigidity/rigidities, material viscosity/viscosities and the like. For example, a deviation in the position and/or orientation of a TCP of a robot due to elastic or temperature-induced deformations may be compensated for on the basis of the parameters of a dynamic model.

According to the invention, such parameters, preferably all parameters of the application taken into account in the planning or controlling, are managed, in particular stored, with the aid of a preferably central graph structure.

Here a graph structure, in the meaning of the present invention, includes in particular one or more nodes, to each of which one or more parameters are assigned, and injective, surjective or bijective relations between these nodes, which are also called lines or edges in graph theory. The graph structure may be directed or non-directed, designed with or without multiple edges and as multigraphs or hypergraphs, and preferably has a tree structure in which exactly one antecedent is assigned to each node.

Management of the parameters in a preferably central graph structure advantageously enables more efficient storage and more efficient access to parameter values, in order to assign values to the latter for example during (re)calibration, parameter identification or optimization. In addition, the consistency of parameters of an application may be ensured.

In particular, parameter values may be matched individually to the particular concrete application or application component. Thus for example, in the case of an absolutely calibrated robot, after an exchange of components, parameters of the exchanged component may be specifically identified and/or updated.

The graph structure too may be matched individually to the application or application components. Thus it is possible for example to match the graph structure to the kinematics, drive technology and/or sensor system of a robot of the application.

A model of the application or of an application component, for example a robot or process model, may then be constructed from the parameters successively, for example dynamically, on the basis of the graph structure. This ensures that up-to-date parameter values are always used in planning or regulation.

According to a preferred embodiment, parameters are managed in clusters. In this case two or more parameters, for example parameters that are only identified together or in their total effect, are combined into a node. Advantageously, this reduces the complexity of the graph structure and illustrates physical interfaces better.

Preferably, relevant parameters for the application are selected from the parameters stored or provided in the graph structure for planning and/or controlling the application. For example, parameters may be provided for a torque ripple or cogging compensation in the drives, which is only necessary however with relatively slow robot movements. Therefore, for planning or controlling fast robot movements, these parameters which are then not relevant can specifically not be selected, which in turn reduces the complexity of the graph structure and for example simplifies optimization.

According to a preferred embodiment, parameter values are preset to nominal values. This enables planning or controlling, on the one hand, without first having to determine and store individual values for these parameters. It is likewise possible for the corresponding parameter to be not selected, as non-relevant, by specifying zero nominal values.

Additionally or alternatively, parameter values may be changeable, in particular selectively, in order for example to adjust them to a robot individually. The changeability may be selective, in particular authorization-specific or user-specific. There may be provision, for example, that only service personnel of the manufacturer are allowed to change safety-relevant parameters, which relate for example to the emergency-off function, qualified start-up personnel of the operator may reconfigure regulating parameters and specify additional axis parameters, and ordinary operators may for example input tool parameters. Additionally or alternatively, permissible (limiting) values or value ranges may be specified for changeable parameters.

In particular for following up on customer problems, but also in order to be able to restore a prior or original configuration more easily, in a preferred embodiment one or more parameter values are secured against change. This may be implemented for example by securing the value of a changeable parameter against change, for example in a copy of the graph structure and its parameter values, for example by storing it in a robot controller or a separate data processing device. It is likewise also possible, conversely, for the planning or controlling to occur on the basis of an updated copy of the original graph structure and its parameter values, in which case the copy contains the changed parameter values and hence the current system state.

According to a preferred embodiment, when exchanging, modifying, adding and/or removing an application component, associated parameters or parameter values are adjusted automatically. Preferably the application component, for example a different robot tool, is delivered with a component-specific data record which contains the individual parameter values. Preferably the associated parameter values are stored on the component itself, and are incorporated into the graph structure using plug & play technology when the component is connected to the total system, for example when the tool is connected to the robot.

Additional advantages and features result from the subordinate claims and the exemplary embodiments. To this end the drawing shows the following, partially in schematic form:

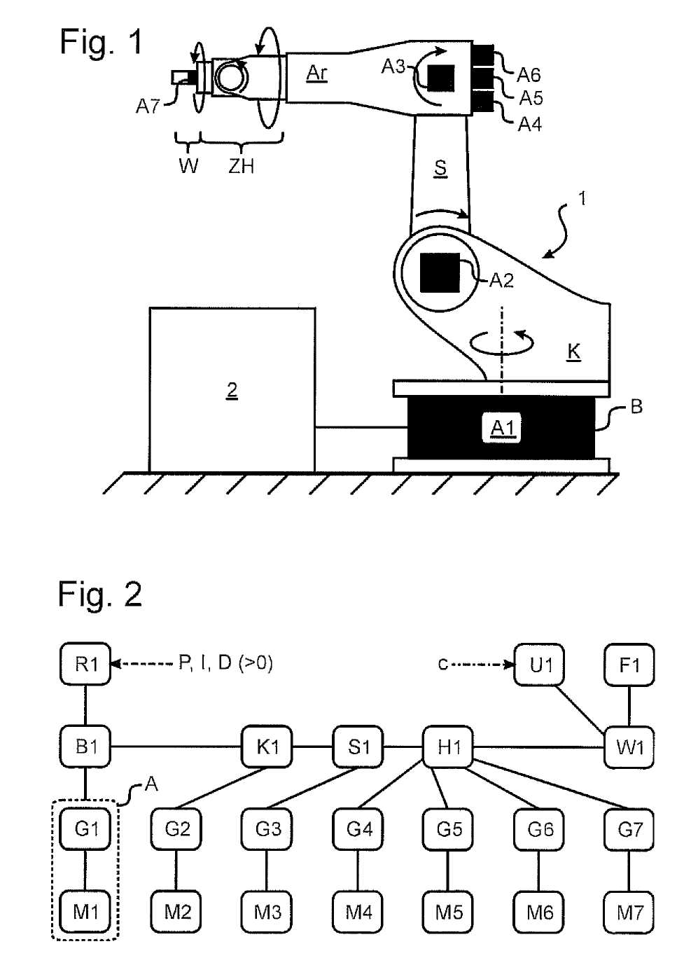

FIG. 1: a robot having a controller according to one version of the present invention, and

FIG. 2: a graph structure according to one embodiment of the present invention in the controller of FIG. 1.

FIG. 1 shows a six-axis articulated-arm robot 1 having a robot controller 2 connected to it, according to one embodiment of the present invention. The drives A1 through A6 of robot 1 and A7 of a gripper W are indicated by solid rectangles, the movement possibilities of the robot by arrows.

Robot 1 has a base B, a carousel K, a motion link S, an arm Ar and a central hand ZH.

In controller 2 a dynamic model is implemented, which illustrates for example rigid-body and/or elastic movements of the robot and drive moments acting on it successively, and thus makes model-based control or path optimization possible. This model includes system parameters, in particular current-torque or voltage-torque conversion factors M1, . . . M7 and transmission friction coefficients and transmission ratios G1, . . . G7 of the seven drives A1 , . . . A7, geometric inertia and rigidity values of the base, the carousel, the motion link, the hand including the arm Ar and central hand ZH, and of the tool B1, K1, S1, H1 or W1, control parameter R1 of the robot controller and parameter S1 of a force sensor (not shown), for example calibration coefficients, as well as process parameters, for example an environment rigidity U1 for modeling a contact between tool W and a workpiece.

These parameters are managed in controller 2 by means of the graph structure sketched in FIG. 2. The latter is matched to the kinematics of the robot application and accordingly has a tree structure, in that for example the motor parameters M1, . . . M7 are linked to the parameters G1, . . . G7 of the transmissions connected to the corresponding motors and those in turn are linked to the parameters B1, K1, S1 or H1 of the corresponding robot component B, K, S, Ar+ZH or W. Thus for example the parameters G2 of the transmission of drive A2, and through them also the parameters M2 of the associated motor, are linked to the parameters K1 of the carousel, on which drive A2 is situated.

As an example, the motor and transmission parameters M1, G1 of drive A1 are clustered into a subsystem A, as indicated by the dashed line in FIG. 2, since for example only the frictional resistance of the entire drive A1 can be measured. Subsystem A is managed accordingly as a node of the graph structure, and thus represents the physical interface. If only the motor of drive A1 is exchanged, for example, the parameters of the entire subsystem A must be newly identified accordingly.

All parameters M1, . . . U1 have nominal values preassigned by the manufacturer. To this end, the robot may for example be calibrated in advance, or parameters may be identified. Individual values for the concrete robot are thereby assigned to all parameters.

Various groups of users can change some of these parameters within predefined limits. For example, start-up personnel can set the proportional, integral and differential amplifications P, I and D of a PID controller; these must be greater than 0. This is indicated by the dashed-dotted arrow in FIG. 2. As indicated by the dashed-dotted arrow in FIG. 2, ordinary operators can for example set a stiffness value c, which describes the contact rigidity of the environment and is taken into account for example in force-regulated joining of the robot.

In both cases, before the new values P, I, D and c specified by the user are stored in the parameters R1 and U1, the previous values are backed up, for example in a copy of the value-confirmed graph structure, in order to make change tracking and restoration possible.

The relevant parameters for the particular application are selected from the parameters managed in the graph structure, and an observer model for example for estimating non-observable condition values, such as the elastic deformations of the robot components, is constructed successively from these, corresponding to the graph structure illustrating the kinematics. For example, for modeling quick robot movements, parameters in M1, . . . M7, which describe a moment ripple or cogging, are ignored, for example by setting them to zero.

Control parameters R1 are normally optimized for the case that the robot is working essentially with its nominal load. If the robot is to be operated with smaller loads, these can be specified for example as environmental parameters U1. Then on the one hand the control parameters R9 can be optimized for this in the process or path plan. On the other hand, during operation, controller 2 can access these changed parameters, which are managed centrally in the graph structure of FIG. 2, and thus control the application optimally.

The central management can be implemented in particular in a computing device, for example a process server or control PC, in order to reduce access times and data transfer. Likewise, it can also be implemented in a distributed configuration, for example by storing the structure in one computing device, while storing parameter values themselves which are managed by the latter in one or more other computing devices.

### REFERENCE LABELS

1 robot
2 controller
A, A1, . . . A7 drive (parameters)
M1, . . . M7 motor parameters
G1, G7 transmission parameters
B(1) base (parameters)
K(1) carousel (parameters)
S(1) motion link (parameters)
H(1) hand (parameters)
W(1) tool (parameters)
U1 environmental parameters
R1 control parameters
F1 force sensor parameters

1. A method for planning and/or controlling a robot application (1) on the basis of system and/or process parameters (M1, . . . M7, G1 , . . . G7, B1, K1, S1, H1, W1, F1, U1, R1), having these steps:
storing parameter values, and
planning and/or controlling the application on the basis of stored parameter values, characterized in that
parameters are managed with the aid of a graph structure (Figure 2).

2. The method according to claim 1, characterized in that parameters are managed centrally and/or in clusters.

3. The method according to one of the preceding claims, characterized in that parameters and/or the graph structure are matched individually to the application or application components.

4. The method according to one of the preceding claims, characterized in that relevant parameters are selected for planning and/or controlling the application.

5. The method according to one of the preceding claims, characterized in that parameter values are preset to nominal values and/or are changeable, in particular selectively.

6. The method according to claim 5, characterized in that a parameter value is backed up before being changed.

7. The method according to one of the preceding claims, characterized in that when exchanging, modifying, adding and/or removing an application component, associated parameters or parameter values are adjusted automatically.

8. A device (2) for automated planning and/or controlling of a robot application (1) on the basis of system and/or process parameters (M1, . . . M7, G1, . . . G7, B1, K1, S1, H1, W1, F1, U1, R1), characterized in that the device for carrying out a method is set up according to one of the preceding claims.

9. A computer program that carries out a method according to one of claims 1 through 7 when it runs in a device according to claim 8.

10. A computer program product having program code that is stored on a machine-readable medium and that includes a computer program according to claim 9.
